(19) United States
(12) Patent Application Publication
(10) Pub. No.: US 2017/0205898 A1
(43) Pub. Date: Jul. 20, 2017

(54) CAPACITANCE PEN, TRANSMITTING TERMINAL AND WIRELESS CHARGING SYSTEM

(71) Applicants: BOE TECHNOLOGY GROUP CO., LTD., Beijing (CN); HEFEI XINSHENG OPTOELECTRONICS TECHNOLOGY CO., LTD., Hefei (CN)

(72) Inventors: Kun LI, Beijing (CN); Yifei ZHAN, Beijing (CN); Tao MA, Beijing (CN)

(21) Appl. No.: 15/209,588

(22) Filed: Jul. 13, 2016

(30) Foreign Application Priority Data
Jan. 20, 2016 (CN) 201610037464.9

(51) Int. Cl. G06F 3/038; G06F 3/0354; H02J 7/02

(52) U.S. Cl. CPC G06F 3/038; H02J 7/025; G06F 3/03545

(57) ABSTRACT

This disclosure provides a capacitance pen, a transmitting terminal and a wireless charging system, for reducing environment pollution caused by waste batteries, prolonging the usage time of the capacitance pen, and improving convenience and practicality for the usage of the capacitance pen. The capacitance pen comprises: a receiving coil for receiving electromagnetic waves; an electromagnetic conversion module, connected with the receiving coil, for converting the received electromagnetic waves into an alternating current; a rectifier and filter voltage regulator module, connected with the electromagnetic conversion module, for rectifying and outputting the alternating current outputted by the electromagnetic conversion module to a functional circuit of the capacitance pen.

### FIELD

This disclosure relates to the field of display technology, particularly to a capacitance pen, a transmitting terminal and a wireless charging system.

### BACKGROUND

With the development of electronic and communication technology, various electronic terminals need to use a stylus pen to replace keyboards or fingers to touch operation screens. For example, many mobile phones and computers are configured with stylus pens to input information. The capacitance pen, which is one kind of stylus pens, has been more and more applied into various electronic devices. The capacitance pen is a pen with conductive property made of conductive materials, for touching the capacitive screen to accomplish human-machine conversation operation.

The capacitance pen is mainly classified into an active capacitance pen and a passive capacitance pen. The passive capacitance pen is the commonly used soft thick-tip pen in the industry. When a user holds a passive capacitance pen, it is conducted with the hand and replaces the hand to touch the screen. However, such a capacitance pen causes small capacitance variation, so a soft head has to be used to increase the touch area so as to increase the capacitance. Moreover, when such a capacitance pen is used to draw on the screen, the user's hand feels bad, and there is no way to measure the touch strength either, hence, the functions such as handwriting recognition and the like cannot be implemented. In terms of the active capacitance pen, a circuit is arranged inside, which can reflect signals and implement many functions. However, the active capacitance pen has to use a power supply. Current active capacitance pens mainly use two kinds of power supplies, one is button cell, and the other is lithium ion battery. The active capacitance pen using the button cell needs to be designed with a detachable structure, so as to facilitate replacement of the battery. Thus, it not only increases the manufacturing difficulty and costs of the capacitance pen, but also has the problem of pollution of waste batteries. The active capacitance pen using the lithium ion battery needs a particular charging device to charge the battery therein when the battery is running low; however, the capacitance pen cannot be used while it is being charged.

### SUMMARY

This disclosure provides a capacitance pen, a transmitting terminal and a wireless charging system, for reducing environment pollution caused by waste batteries, prolonging the usage time of the capacitance pen, and improving use convenience and practicality of the capacitance pen.

According to an aspect, this disclosure provides a capacitance pen, comprising:

a receiving coil for receiving electromagnetic waves;

an electromagnetic conversion module, connected with the receiving coil, for converting the received electromagnetic waves into alternating current;

a rectifier and filter voltage regulator module, connected with the electromagnetic conversion module, for rectifying and outputting the alternating current outputted by the electromagnetic conversion module to a functional circuit of the capacitance pen.

The capacitance pen provided by this disclosure is used in cooperation with a transmitting terminal that transmits electromagnetic waves. The transmitting terminal can transmit electromagnetic waves, and the receiving coil of the capacitance pen can receive the electromagnetic waves transmitted by the transmitting terminal. In this way, the electromagnetic waves can be directly and efficiently transmitted in a nonradiative manner between the transmitting terminal and the receiving coil. The receiving coil is connected with an electromagnetic conversion module. The electromagnetic conversion module can convert the electromagnetic waves received by the receiving coil into an alternating current and transmit it to a rectifier and filter voltage regulator module. The rectifier and filter voltage regulator module converts the alternating current into a direct current and stablizes the voltage value outputted by it at a driving voltage amplitude required by normal operation of the functional circuit of the capacitance pen, thereby providing stable power for the functional circuit of the capacitance pen.

The capacitance pen provided by this disclosure does not need to arrange a battery inside; hence, it can reduce environment pollution caused by waste batteries. In addition, it does not require separate time for charging the capacitance pen provided by this disclosure; hence, it can prolong the usage time of the capacitance pen, and improve the convenience and practicality for the usage of the capacitance pen. Electromagnetic resonant wireless power transmission belongs to a medium and long distance wireless power transmission technology, the effective current-carrying distance of which is much longer than that of the oscillation circuit charging mode in the prior art.

In an embodiment, the capacitance pen further comprises: an electromagnetic resonance module, electrically connected with the receiving coil, for adjusting a frequency of the capacitance pen so as to enable the frequency of the capacitance pen to be the same as that of a transmitting terminal for transmitting electromagentic waves. The electromagnetic resonance module can cause the electromagentic waves generated by the receiving coil and the transmitting terminal to generate electromagnetic resonance.

In an embodiment, the capacitance pen further comprises: a frequency modulation switch arranged on a body of the capacitance pen and electrically connected with the electromagnetic resonance module. The frequency modulation switch can perform fine frequency modulation in real time, thereby modulating the frequency of the capacitance pen better, so as to enable the frequency of the capacitance pen to be the same as that of the transmitting terminal for transmitting electromagentic waves.

In an embodiment, the receiving coil, the electromagnetic conversion module, the electromagnetic resonance module, the rectifier and filter voltage regulator module and the functional circuit are arranged within the body of the capacitance pen.

In an embodiment, along a direction from a penpoint of the capacitance pen to a tailend of the capacitance pen: the electromagnetic resonance module, the receiving coil, the electromagnetic conversion module and the rectifier and filter voltage regulator module are arranged successively.

According to another aspect, this disclosure further provides a transmitting terminal, comprising:

an alternating current conversion module, electrically connected with a power supply, for magnifying and converting a current generated by the power supply into an alternating current;

a wireless power transmission module, electrically connected with the alternating current conversion module, for converting the alternating current generated by the alternating current conversion module into an electromagnetic wave and propagating it outwards.

In the transmitting terminal provided by this disclosure, the alternating current conversion module is driven by a power supply to generate an alternating current of one to ten trillion frequencies, which is power magnified to about 1W and is transmitted to the wireless power transmission module; the wireless power transmission module can convert the alternating current into an electromagnetic wave efficiently and propagate it outwards.

In an embodiment, the wireless power transmission module comprises:

an impedance matching module for adjusting an impedance of the transmitting terminal to match with that of the capacitance pen;

a transmitting coil for transmitting electromagnetic waves.

The internal resistance of the power supply and the characteristic impedance of the connected transmission line are equal and of the same phase, and the characteristic impedance of the transmission line and the connected load impedance are equal and of the same phase. The above two cases are respectively called the input terminal and the output terminal of the transmission line being in an impedance matching state, for short, impedance matching.

In an embodiment, the transmitting coil is arranged around an outer contour of a display area of the transmitting terminal, and the alternating current conversion module and the impedance matching module are located within an area enclosed by the transmitting coil. Such an arrangement can save the space occupied by the transmitting coil.

In an embodiment, the display area of the transmitting terminal is a rectangle, a housing of the transmitting terminal is provided with a groove around the display area of the transmitting terminal, and the transmitting coil is arranged within the groove.

In an embodiment, the power supply and the transmitting terminal are in an integral structure.

In an embodiment, the power supply and the transmitting terminal are in separate structures.

In an embodiment, the transmitting terminal is a mobile terminal or a tablet display device.

According to a further aspect, this disclosure further provides a wireless charging system, comprising a capacitance pen stated in any of the above embodiments and a transmitting terminal stated in any of the above embodiments.

When the wireless charging system provided by this disclosure is in use, the capacitance pen does not have to be charged separately, and there is no need to arrange any battery within the capacitance pen. When the capacitance pen is being used, the transmitting terminal can provide electric energy for it continuously; therefore, the wireless charging system provided by this disclosure has better practicality and a relatively long life time.

### BRIEF DESCRIPTION OF THE DRAWINGS

The drawings explained here are used for providing a further understanding to this disclosure, and constitute a part of this disclosure. The schematic embodiments of this disclosure and the illustrations thereof are only used for explanation, and do not constitute inappropriate definitions to this disclosure. In the drawings:

FIG. 1 is a structural schematic view of a capacitance provided by this disclosure;

FIG. 2 is a structural schematic view of a transmitting terminal provided by this disclosure;

FIG. 3 is a structural schematic view of a wireless charging system provided by this disclosure.

### DETAILED DESCRIPTION

Next, the technical solutions in the embodiments of this disclosure will be described clearly and completely with reference to the drawings. Apparently, the embodiments described are only a part of rather than all of the embodiments of this disclosure.

In the drawings

1-functional circuit

21-receiving coil

22-electromagnetic resonance module

23-electromagentic conversion module

3-rectifier and filter voltage regulator module

4-power supply

5-alternating current conversion module

6-wireless power transmission module

61-impedance matching module

62-transmitting coil

71-pen body

72-pen head

8-electrode

As shown in FIG. 1, FIG. 1 is a structural schematic view of a capacitance provided by this disclosure. The capacitance pen comprises: a receiving coil 21 for receiving electromagnetic waves; an electromagnetic conversion module 23, connected with the receiving coil 21, for converting the received electromagnetic waves into alternating current; a rectifier and filter voltage regulator module 3, connected with the electromagnetic conversion module 23, for rectifying and outputting the alternating current outputted by the electromagnetic conversion module 23 to a functional circuit 1 of the capacitance pen.

The capacitance pen is used in cooperation with a transmitting terminal that transmits electromagnetic waves. The transmitting terminal can transmit electromagnetic waves. When the capacitance pen is used, the receiving coil 21 of the capacitance pen can receive the electromagnetic waves transmitted by the transmitting terminal, in this way, the electromagnetic waves can be directly and efficiently transmitted in a nonradiative manner between the transmitting terminal and the receiving coil 21. The receiving coil 21 is connected with an electromagnetic conversion module 23. The electromagnetic conversion module 23 can convert the electromagnetic waves received by the receiving coil 21 into an alternating current and transmit it to a rectifier and filter voltage regulator module 3. The rectifier and filter voltage regulator module 3 converts the alternating current into a direct current and stablizes the voltage value outputted by it at a driving voltage amplitude required by normal operation of the functional circuit 1 of the capacitance pen, thereby providing stable power for the functional circuit of the capacitance pen.

The capacitance pen provided by this disclosure does not need to arrange a battery inside; hence, it can reduce environment pollution caused by waste batteries. In addition, it does not require separate time for charging the capacitance pen provided by this disclosure; hence, it can prolong the usage time of the capacitance pen, and improve the convenience and practicality for the usage of the capacitance pen. Electromagnetic resonant wireless power transmission belongs to a medium and long distance wireless power transmission technology, the effective current-carrying distance of which is much longer than that of the oscillation circuit charging mode in the prior art.

The capacitance pen generally comprises a pen body 71 and a pen head 72. An electrode 8 is arranged within the pen head 72. The capacitance pen may further comprise an electromagnetic resonance module 22 electrically connected with the receiving coil 21. The electromagnetic resonance module 22 is used for adjusting a frequency of the capacitance pen so as to enable the frequency of the capacitance pen to be the same as that of a transmitting terminal for transmitting electromagentic waves. The transmission efficiency is the highest in the case of electromagentic resonance. The electromagnetic resonance module can cause the electromagnetic waves generated by the receiving coil and the transmitting terminal to generate electromagentic resonance. The transmission efficiency of the electromagnetic waves in the case of electromagentic resonance is relatively high.

The capacitance pen may further comprise a frequency modulation switch arranged on the body 71 of the capacitance pen and electrically connected with the electromagnetic resonance module 22. The frequency modulation switch can perform fine frequency modulation in real time, thereby modulating the frequency of the capacitance pen better, so as to enable the frequency of the capacitance pen to be the same as that of the transmitting terminal for transmitting electromagentic waves.

The above receiving coil 21, electromagnetic conversion module 23, electromagnetic resonance module 22, rectifier and filter voltage regulator module 3 and functional circuit 1 can be arranged within the body 71 of the capacitance pen. Respective accommodating grooves can be arranged within the body 71. The above receiving coil 21, electromagnetic conversion module 23, electromagnetic resonance module 22, rectifier and filter voltage regulator module 3 and functional circuit 1 can be arranged within the respective accommodating grooves.

This disclosure does not define the specific positions and arrangement modes of the above receiving coil 21, electromagnetic conversion module 23, electromagnetic resonance module 22, rectifier and filter voltage regulator module 3 and functional circuit 1 within the capacitance pen specifically. Optionally, along a direction from a penpoint of the capacitance pen to a tailend of the capacitance pen: the electromagnetic resonance module 22, the receiving coil 21, the electromagnetic conversion module 23 and the rectifier and filter voltage regulator module 3 are arranged successively.

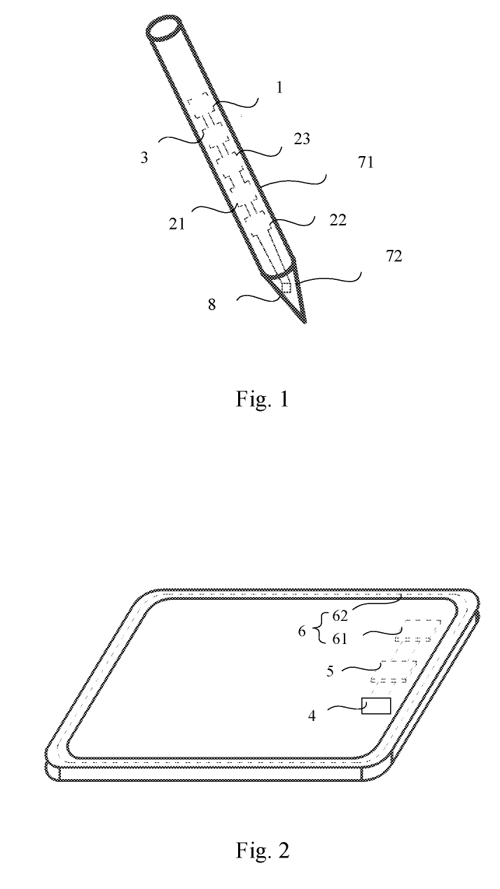

As shown in FIG. 2, FIG. 2 is a structural schematic view of a transmitting terminal provided by this disclosure. The transmitting terminal comprises an alternating current conversion module 5. The alternating current conversion module 5 is electrically connected with a power supply 4, for magnifying and converting a current generated by the power supply 4 into an alternating current. The transmitting terminal further comprises a wireless power transmission module 6. The wireless power transmission module 6 is electrically connected with the alternating current conversion module 5, for converting the alternating current generated by the alternating current conversion module 5 into an electromagnetic wave and propagating it outwards.

In the transmitting terminal provided by this disclosure, the alternating current conversion module 5 is driven by a power supply 4 to generate an alternating current of one to ten trillion frequencies, which is power magnified to about 1W and is transmitted to the wireless power transmission module 6; the wireless power transmission module 6 can convert the alternating current into an electromagnetic wave efficiently and propagate it outwards.

The wireless power transmission module 6 may further comprise: an impedance matching module 61 and a transmitting coil 62. The impedance matching module 61 is used for adjusting an impedance of the transmitting terminal to match with that of the capacitance pen. The transmitting coil 62 is used for transmitting electromagnetic waves.

The above transmitting coil may have various specific positions. In a specific implementation, the transmitting coil 62 is arranged around an outer contour of a display area of the transmitting terminal, the alternating current conversion module 5 and the impedance matching module 61 are located within an area enclosed by the transmitting coil 62. Such an arrangement can save the space occupied by the transmitting coil 62.

The display area of the transmitting terminal can be a rectangle. A housing of the transmitting terminal is provided with an embedded groove around the display area of the transmitting terminal, and the transmitting coil is arranged within the embedded groove. That is, the transmitting coil cannot be seen at the display side of the transmitting terminal.

The housing of the transmitting terminal can be provided with a groove around the display area of the transmitting terminal, and the transmitting coil is arranged within the groove. A cover can be arranged on the upper surface of the groove for preventing the transmitting coil from being polluted. The arrangement of the groove is convenient for replacement of the transmitting coil.

The power supply and the transmitting terminal can be either in an integral structure or in separate structures. When the power supply and the transmitting terminal are in separate structures, the power supply is arranged at the outside of the transmitting terminal and is electrically connected with the transmitting terminal.

The transmitting terminal can be a mobile terminal or a tablet display device, e.g.: terminal display products such as mobile phones and tablet computers.

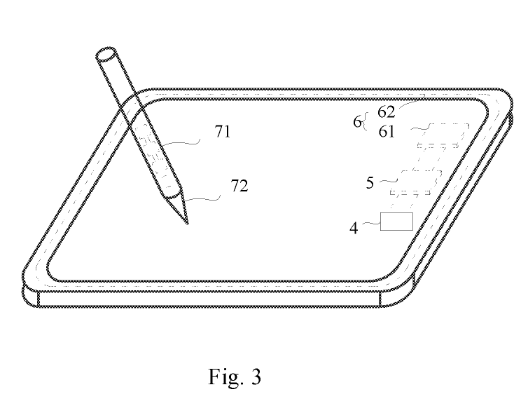

As shown in FIG. 3, FIG. 3 is a structural schematic view of a wireless charging system provided by this disclosure. The wireless charging system comprises a capacitance pen stated in any of the above embodiments and a transmitting terminal stated in any of the above embodiments.

When the wireless charging system provided by this disclosure is in use, the capacitance pen does not have to be charged separately, and there is no need to arrange any battery within the capacitance pen. When the capacitance pen is being used, the transmitting terminal can provide electromagnetic waves for it continuously. The receiving coil arranged within the capacitance pen can receive the electromagnetic waves transmitted by the transmitting terminal. In this way, the electromagnetic waves can be directly and efficiently transmitted in a nonradiative manner between the transmitting terminal and the receiving coil. The electromagnetic conversion module arranged within the capacitance pen is connected to the receiving coil and can convert the electromagnetic waves received by the receiving coil into an alternating current and transmit it to a rectifier and filter voltage regulator module. The rectifier and filter voltage regulator module converts the alternating current into a direct current and stablizes the voltage value outputted by it at a driving voltage amplitude required by normal operation of the functional circuit of the capacitance pen, thereby providing stable power for the functional circuit of the capacitance pen. Therefore, the wireless charging system provided by this disclosure has better practicality and a relatively long life time.

Apparently, the skilled person in the art can make various modifications and variations to the embodiments of this disclosure without departing from the spirit and the scope of this disclosure. In this way, provided that these modifications and variations belong to the scopes of the claims of this disclosure and the equivalent technologies thereof, this disclosure also intends to encompass these modifications and variations.

1. A capacitance pen, comprising:
a receiving coil for receiving electromagnetic waves;
an electromagnetic conversion module, connected with the receiving coil, for converting the received electromagnetic waves into an alternating current;
a rectifier and filter voltage regulator module, connected with the electromagnetic conversion module, for rectifying and outputting the alternating current outputted by the electromagnetic conversion module to a functional circuit of the capacitance pen.

2. The capacitance pen according to claim 1, further comprising:
an electromagnetic resonance module, electrically connected with the receiving coil, for adjusting a frequency of the capacitance pen so as to enable the frequency of the capacitance pen to be the same as that of a transmitting terminal for transmitting electromagentic waves.

3. The capacitance pen according to claim 2, further comprising: a frequency modulation switch arranged on a body of the capacitance pen and electrically connected with the electromagnetic resonance module.

4. The capacitance pen according to claim 2, wherein the receiving coil, the electromagnetic conversion module, the electromagnetic resonance module, the rectifier and filter voltage regulator module and the functional circuit are arranged within the body of the capacitance pen.

5. The capacitance pen according to claim 4, wherein along a direction from a penpoint of the capacitance pen to a tailend of the capacitance pen: the electromagnetic resonance module, the receiving coil, the electromagnetic conversion module and the rectifier and filter voltage regulator module are arranged successively.

6. A transmitting terminal, comprising:
an alternating current conversion module, electrically connected with a power supply, for magnifying and converting a current generated by the power supply into an alternating current;
a wireless power transmission module, electrically connected with the alternating current conversion module, for converting the alternating current generated by the alternating current conversion module into an electromagnetic wave and propagating it outwards.

7. The transmitting terminal according to claim 6, wherein the wireless power transmission module comprises:
an impedance matching module for adjusting an impedance of the transmitting terminal to match with that of the capacitance pen;
a transmitting coil for transmitting electromagnetic waves.

8. The transmitting terminal according to claim 7, wherein the transmitting coil is arranged around an outer contour of a display area of the transmitting terminal, the alternating current conversion module and the impedance matching module are located within an area enclosed by the transmitting coil.

9. The transmitting terminal according to claim 8, wherein the display area of the transmitting terminal is a rectangle, a housing of the transmitting terminal is provided with a groove around the display area of the transmitting terminal, and the transmitting coil is arranged within the groove.

10. The transmitting terminal according to claim 6, wherein the power supply and the transmitting terminal are in an integral structure.

11. The transmitting terminal according to claim 6, wherein the power supply and the transmitting terminal are in separate structures.

12. The transmitting terminal according to claim 6, wherein the transmitting terminal is a mobile terminal or a tablet display device.

13. A wireless charging system, comprising a capacitance pen as claimed in claim 1 and a transmitting terminal as claimed in claim 6.

14. The wireless charging system according to claim 13, wherein the capacitance pen further comprises:
an electromagnetic resonance module, electrically connected with the receiving coil, for adjusting a frequency of the capacitance pen so as to enable the frequency of the capacitance pen to be the same as that of a transmitting terminal for transmitting electromagentic waves.

15. The wireless charging system according to claim 14, wherein the capacitance pen further comprises: a frequency modulation switch arranged on a body of the capacitance pen and electrically connected with the electromagnetic resonance module.

16. The wireless charging system according to claim 14, wherein the receiving coil, the electromagnetic conversion module, the electromagnetic resonance module, the rectifier and filter voltage regulator module and the functional circuit are arranged within the body of the capacitance pen.

17. The wireless charging system according to claim 13, wherein the wireless power transmission module comprises:
an impedance matching module for adjusting an impedance of the transmitting terminal to match with that of the capacitance pen;
a transmitting coil for transmitting electromagnetic waves.

18. The wireless charging system according to claim 17, wherein the transmitting coil is arranged around an outer contour of a display area of the transmitting terminal, and the alternating current conversion module and the impedance matching module are located within an area enclosed by the transmitting coil.

19. The wireless charging system according to claim 18, wherein the display area of the transmitting terminal is a rectangle, a housing of the transmitting terminal is provided with a groove around the display area of the transmitting terminal, and the transmitting coil is arranged within the groove.

20. The wireless charging system according to claim 13, wherein the power supply and the transmitting terminal are in an integral structure or in separate structures.
